(19) United States
(12) Patent Application Publication
(10) Pub. No.: US 2005/0127176 A1
(43) Pub. Date: Jun. 16, 2005

(54) Multi label verification system

(76) Inventors: Robert Dickinson, London (GB); David Arnold, Surrey (GB)

Correspondence Address: FULWIDER PATTON LEE & UTECHT, LLP;HOWARD HUGHES CENTER, 6060 CENTER DRIVE, TENTH FLOOR, LOS ANGELES, CA, 90045, US

(21) Appl. No.: 10/500,652

(22) PCT Filed: Dec. 19, 2002
(86) PCT No.: PCT/GB02/05801

(30) Foreign Application Priority Data
Jan. 4, 2002 (GB) 0200159.2
Aug. 22, 2002 (GB) 0219631.9

(51) Int. Cl. G06F 17/60

(52) U.S. Cl. 235/385

(57) ABSTRACT

The present application relates to techniques and systems which employ labels, for example on articles such as consumer products and their packaging, in order to verify the authenticity of those articles, and/or to allow unauthorised tampering of those articles to be detected and/or to allow tracking and tracing of those articles. An system is provided having at least one primary label and at least one secondary label. There exists an association between the information contained in the or each secondary label and one or more of the properties of the or each primary label so that unauthorised tampering of the articles to which the labels are attached can be detected.

The present invention relates to techniques and systems which employ labels, for example on articles such as consumer products and their packaging, in order to verify the authenticity of those articles, and/or to allow unauthorised tampering of those articles to be detected and/or to allow tracking and tracing of those articles.

It is common for genuine consumer articles to carry some kind of information carrier which can, on the simplest level, provide a means to verify the authenticity of an article merely by sensing its presence on the article. More complex tags are also known which have been encoded in some way so that they carry information about, for example, the manufacturer or the supplier of the article. Verifying the authenticity of an article can be particularly difficult in situations where counterfeit and genuine products are mixed; for example, when a counterfeit article is packed in a genuine box carrying a verification label, or visa versa.

There is a need for brand owners in particular to be able to examine their products both within a distribution chain and a retail environment and determine if a product is genuine and within its original packaging.

Preferred embodiments of the present invention therefore seek to provide a system which allows the unauthorised mixing of counterfeit and genuine articles/packaging to be detected. It is also desirable in a number of commercial situations to be able to detect if articles or their packaging have been tampered with. Furthermore, it would also be advantageous to have the capability to check the authenticity of consumer products packed within, for example, a shipping case, without having to open the case and remove the individual product boxes. This would be particularly useful when carrying out raids or inspections of suspect shipments in distribution centres, since it is usual for counterfeit products to enter the supply chain via the distribution channels. Enabling the rapid and reliable inspection of consumer products, packaged in bulk, therefore has considerable commercial potential.

According to the present invention there is provided a method of providing means for detecting counterfeit articles and/or for detecting unauthorised tampering of articles/article packaging and/or for tracking articles, the method comprising the steps of:
i) determining one or more properties of an at least one primary label or of an article to which the or each label is, or is to be, attached; and
ii) encoding at least one secondary label with information about the one or more properties determined in step (i), such that there exists an association between the information contained in the or each secondary label(s) and one or more of the properties of the or each primary label.

The properties determined in step i) may be, for example, the magnetic properties of the primary label(s), the number encoded by the primary label(s) or the position of the primary label(s) (and thus the article to which it is attached) within a packaging box.

According to a second aspect of the present invention there is provided a method of detecting counterfeit articles and/or detecting unauthorised tampering of articles/article packaging and/or for tracking articles, the method comprising the steps of:
i) determining one or more given properties of an at least one primary label(s), or the article to which the label(s) is attached;
ii) determining the information encoded by an at least one secondary label(s); and
iii) checking for the existence of a predetermined association between the information determined in steps i) and ii).

According to a further aspect of the present invention there is provided a verification system comprising at least one primary label and at least one secondary label, wherein there exists an association between the information contained in the or each secondary label and one or more of the properties of the or each primary label.

Therefore, in accordance with embodiments of the present invention, it is possible for the or each secondary label to carry information about, for example, the magnetic properties of the primary label or, alternatively, the positional properties of the or each primary label(s).

By applying the primary label to a consumer article and the secondary label to the article packaging, it becomes possible for preferred embodiments of the present invention to provide a means of verifying the authenticity and/or checking the identity of both an article and its packaging by checking for the required association between the primary and secondary labels. Thus, problems which may occur when counterfeit/genuine products/packaging are mixed are alleviated.

According to an embodiment of the first aspect of the present invention, the secondary label is encoded with information about the position of the primary label (and thus the article to which it is attached) within a case containing a number of articles. This may be achieved by specifying the positional information (in encoded form on the secondary label(s)) of the primary label. It therefore becomes possible to determine not only if the articles are genuine, but also if the box has been tampered with, and if the positions of the articles within the box have been altered in any way. In this example, a primary label is provided which, in its simplest form, merely acts as a presence indicator. A secondary label is provided which is encoded with information about the position of the primary label at the time of packaging. In order to achieve this, the primary label is attached to an article which is packaged within a box. The position of the label, and thus the article to which it is attached, is determined by means of a scanning device which allows the coordinates of the primary label within the box to be obtained.

The position is then represented in encoded form on the secondary label which is attached to the external packaging. Obviously a higher level of security is achieved by providing a number of articles at different locations within the box with primary labels; the positional properties of each of them being represented in some form by the secondary label.

In another embodiment according to a first aspect of the present invention, it may be convenient for all of the articles to be provided with labels bearing different numbers or a random selection of numbers. The articles are packaged into a box and during the process of encoding the secondary label(s), the operator may follow a predetermined procedure for determining a given property of the primary label(s). For example, the operator may follow a procedure which requires that the label attached to the packaged article at the top left and top right of the packaging box respectively, are to form the primary labels for the system. These labels will be scanned in order to determine the number of the articles (say 157 and 273) and the information is then used to form the code of the secondary label. On a first level, this could simply be 157273. Alternatively, a higher level of security could be provided by subjecting the information to an algorithm before encoding the secondary label.

Methods according to embodiments of the second aspect of the present invention may be carried out in order to check for the presence of an association that should exist between the primary label(s) and the secondary label(s). For instance, in the example described above in which the positional property of the primary label(s) is used to encode the secondary label(s), a check is done to see if there is a “match” between the actual position of the label within the packaging and the positional information encoded by the secondary label. This is achieved by subjecting the primary label(s) to an interrogation field to ascertain its position. An operator can then read the information encoded by the secondary label(s) and, taking into account any algorithm that may have been applied to the primary information, confirm that the required association exists between the primary and secondary labels. If the verification fails, this is evidence that the articles and/or the packaging have been tampered with.

If the secondary label has been encoded by scanning the primary labels according to a predetermined procedure as described above, checks may then be performed, in accordance with that procedure, to check for the presence of the association that should exist between the primary labels and the secondary label. An operator will therefore scan the top left article followed by the top right article, thereby subjecting the labels attached to those articles to an interrogation field to determine the label number. This is then compared to the information encoded by the secondary label on the outside of the packaging, taking into account any algorithms that may have been applied to the primary information, to see if required association exists.

There are a number of benefits offered by preferred embodiments of the present invention. Importantly, methods according to the second aspect of the invention create a new level of defence against tampering, since a simple handheld reader allows individual product boxes to be checked for authenticity and to see if tampering has taken place. Unlike previously considered techniques, the present invention does not require access to a database or online verification, so that verification can be virtually instantaneous.

Furthermore, the system itself is covert and inconspicuous so that any attempt to remove the secondary label would in itself indicate tampering.

Primary labels may advantageously carry a code in order to offer an additional level of security against counterfeit mixing and to allow the tracking and tracing of articles. In this embodiment the primary label(s) may advantageously carry a relatively simple code, whereas the secondary label(s) may carry a more complex code. The secondary label will therefore represent more detailed information, for example, about the article to which it is attached. Although the data content of the primary and secondary labels is different, the secondary label will also contain information about what the primary label should read if the labels are correctly “matched”.

It is then possible for the labels to be scanned to verify the association between them at any stage. This can be achieved by means of an algorithm which links the information content of the labels so that, by interrogating the more complex secondary label, it is possible to determine what the primary label should read for there to be a match. In this embodiment, the labels are preferably manufactured so that the primary and secondary labels are initially physically linked, in the form of a tag with several parts, at least one of which being detachable. In this way it is possible for one of the parts to be detached from the primary label attached to the article, for example during the packaging process, and then applied as an external code to the outside of the packaging.

An advantage of this embodiment is that since the different parts (i.e. primary and secondary) are manufactured as a single label, it is possible for the data content of each of the labels, and the associated data between the labels to be tightly controlled at the point of manufacture, rather than relying on an operator to encode the secondary label.

Preferably, the entire label may be machine applied to an article in a single operation. It is envisaged that during the pre-sale lifetime of the article, at least one of the secondary labels may be detached and retained by the manufacturer/vendor of the product and/or applied to the external packaging of the article during the packaging process. Furthermore, a tertiary label may also be provided which is intended to be applied post sale to a device which operates in accordance with, or interacts with, the article. The advantage of this embodiment can be appreciated by considering the case of an item of hardware, such as a modem or a graphics/sound card. The tertiary label, which will be detachable from the software packaging, may be applied by an end user to their PC once the software has been installed or fitted to the motherboard. It then becomes possible for the label to be scanned, for example by a representative of the software manufacturer or a technical agent, to verify a number of parameters such as the make of software, the licence number of the software or the specification of the installed software.

It is envisaged in some embodiments that the primary label may itself function as a means for auditing and/or tracing the software, particularly in circumstances where the packaging is not likely to be retained by the end user. In this case, the primary label may be removed from an internal article by an end user and applied to a device which operates in accordance with, or interacts with, the article.

In a preferred embodiment, the primary label carries a relatively simple code which can be read by an interrogating field without requiring a high degree of accuracy in positioning between the interrogation field and the label. This will allow interrogation to be carried out over a relatively large range and through a number of layers of packaging. This primary label may preferably be intended to be permanently affixed to the article so that it becomes a permanent “internal” label.

The use of coded primary tags may also be advantageous in situations where a number of articles are to be packaged into a single box, each of which carries a coded label so that every article has a unique identity. The articles may then be packaged into the box in a random way. The magnetic “characteristic”, or code, of (say) two of the labels situated in predetermined locations of the box is determined (these labels thus becoming the primary labels), and this information is used to encode the secondary label which is secured to the outside of the packaging box. Therefore, by reading the secondary label and one or more of the primary labels it is possible to ascertain if there has been any tampering of the packaging.

The labels of the present invention are advantageously remotely detectable. Preferred embodiments of the present invention comprise labels having magnetically active material which will respond to an applied magnetic interrogation field. Embodiments relying on optical detection techniques are also envisaged, either alone or in addition to magnetic coding, however these obviously suffer from the disadvantage that a line of sight is required between a reading device and the label(s). Therefore an advantage of using magnetic labels is that the primary label(s) can be interrogated while being contained within a sealed box, such as a shipping case or container.

Any of the embodiments described herein may also feature a human readable number allowing primary verification if necessary.

One of the labels may, in some embodiments, also function as a security tag, so that if it were still active when the product was passed through an interrogating magnetic field, it would cause an alarm to be initiated. It may also be desirable for one part of the label to be “tamper evident” to help prevent against unauthorised removal.

Preferred embodiments of the present invention exhibit the benefits associated with providing a single, complex internal label, in terms of the level of data content and the functionality of the label, by providing a simpler internal code which is linked or associated with a more complex external code.

It is also envisaged that at least one tertiary label may be provided which can be removed and affixed to a device which operates in accordance with, or interacts with, the article. Preferably there would be an association between the data content of this label and one or both of the primary/secondary labels.

Other optional features of the labels embodying the present invention comprise the use of “toggle tags” i.e. tags or labels that can be erased or have their state changed, labels which utilise a combination of magnetic material and holograms or labels which employ invisible ink barcodes, or which could be applied to an article or article as a transfer film.

For a better understanding of the present invention, and to show how the same may be carried into effect, reference will now be made, by way of example, to the accompanying drawings, in which:

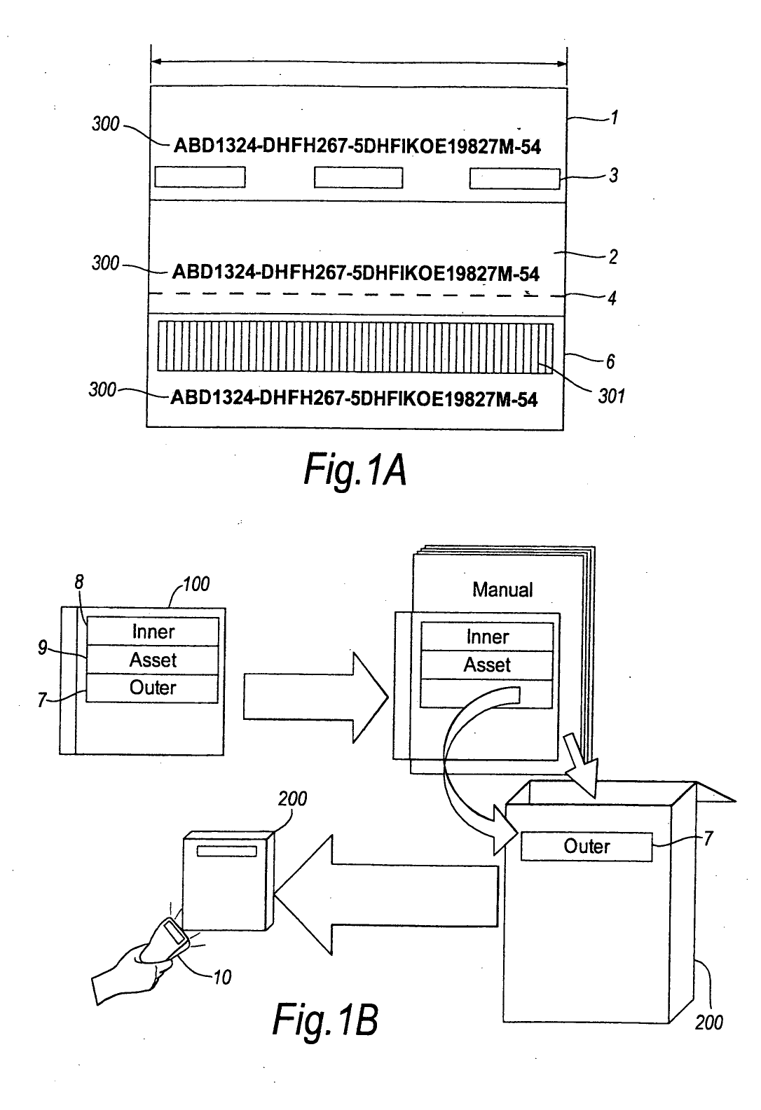

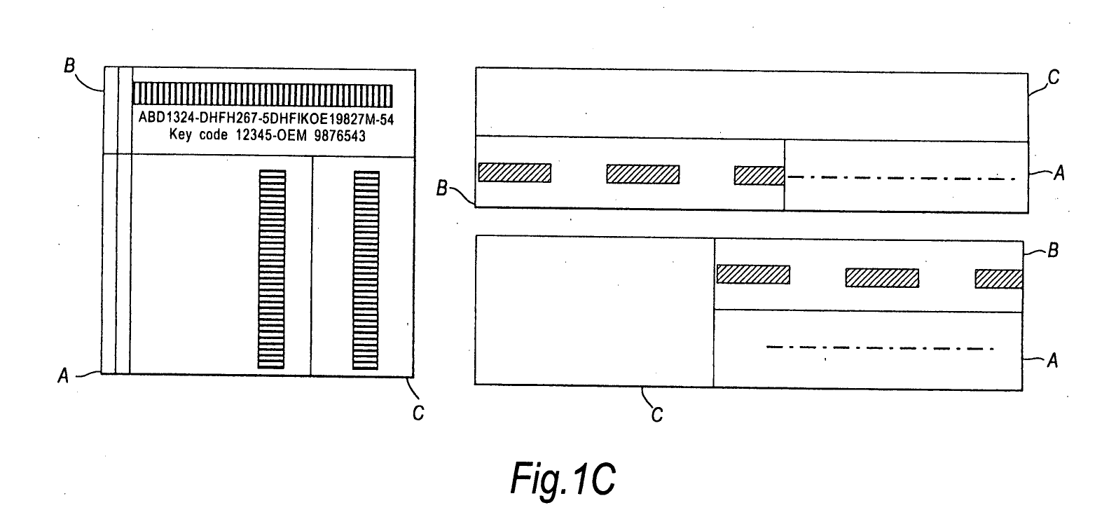

FIG. 1A shows a multi-part information carrier embodying the present invention, comprising a primary information label and a secondary information label wherein there exists an association in the data content of the primary and secondary labels;

FIG. 1B shows a multi-part information carrier as applied to a CD and its packaging;

FIG. 1C illustrates further examples of multi-part label configurations embodying the present invention;

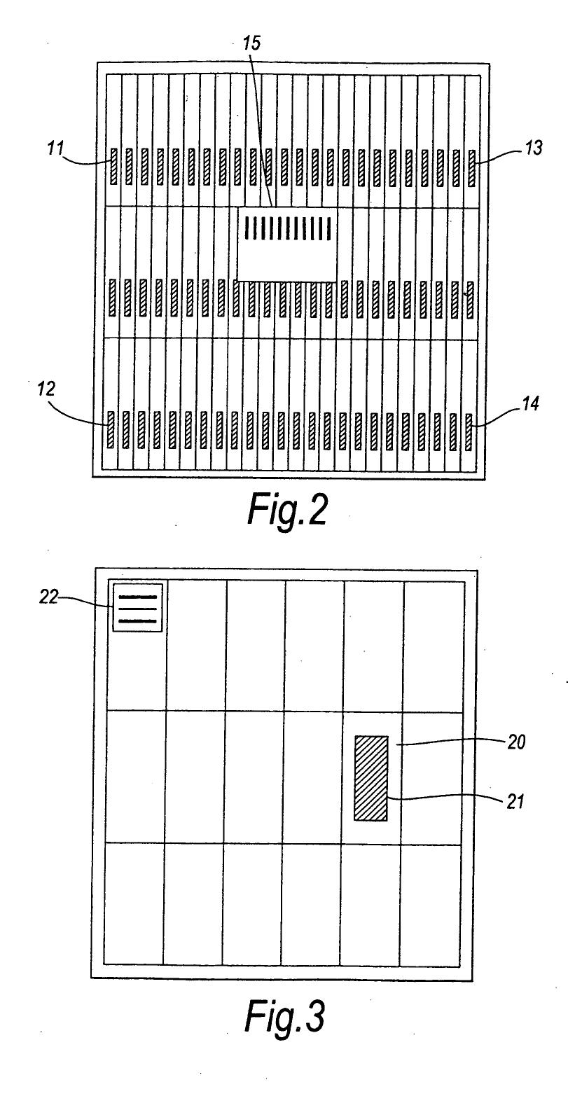

FIG. 2 illustrates an embodiment of the present invention in which a secondary label is encoded with information about the properties of four primary labels;

FIG. 3 illustrates an embodiment of the present invention in which a secondary label is encoded with information about the positional properties of a primary Label;

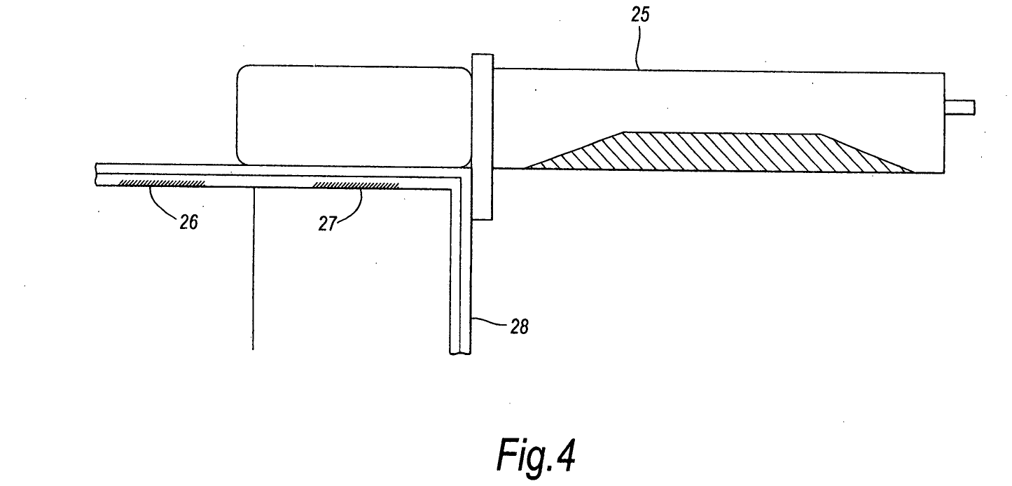

FIG. 4 illustrates a reading device which is suitable for determining the positional properties of the primary labels shown in FIG. 2; and

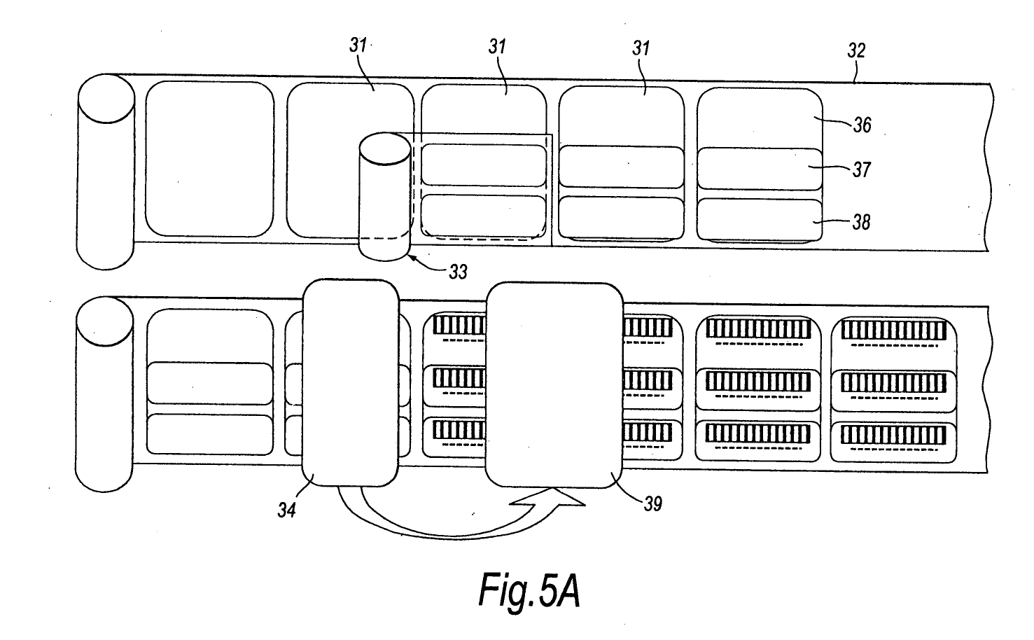

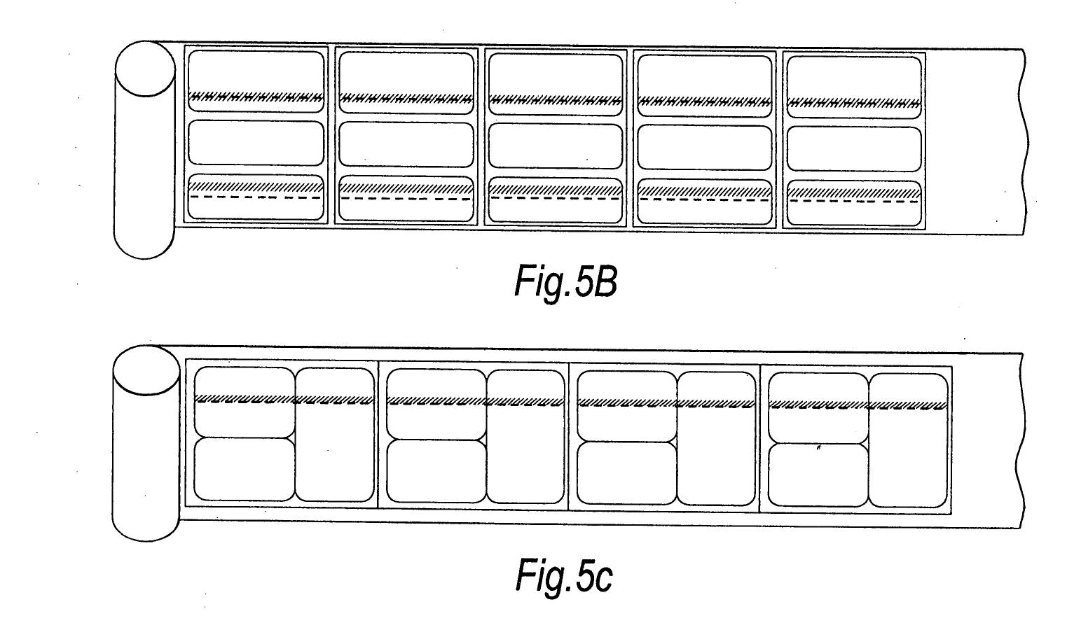

FIG. 5 shows the way in which a multi-part label embodying the present invention may be manufactured and stored.

FIG. 1A shows a multi-part information carrier embodying the present invention, comprising a primary label 1 and a secondary label 2 wherein there exists an association in the data content of the primary and secondary labels.

The primary label 1 is, in this example, provided with a simple code 3, consisting of three magnetic strips of magnetic material, whereas the secondary label 2 is provided with a more complex magnetic code 4, the data content of which is associated with the data content of the primary label 1. This association may be confirmed by reading both the primary label and the secondary label and with knowledge of the secure algorithm that is associated with them.

In addition a tertiary label 6 having an optical bar code 301 is provided which is detachable and may be used for purposes of asset tracking and auditing of the consumer article. All of the labels in this embodiment are provided with a human readable number 300 to allow primary verification if necessary.

FIG. 1B shows the way in which a multi-part labelmay be applied to a consumer article, which in this example comprises a CD.

It is envisaged that the entire label is applied to the CD at the point of manufacture. The data content of each of the parts varies, however there is an association between the information on two of the parts 7 and 8. The CD 100, with attached multi-part label, is then passed to the point of packaging. During the packaging process, the secondary label 7 is attached to an outer packaging box 200. This part 7 may be encoded using optically encrypted code and/or magnetic code having a plurality of magnetic elements as shown in FIG. 1A. Both the primary (inner) label 8 and the secondary (outer) label 7 may be encoded using a number of technologies such as those described in WO 97/04338 and WO 96/31790 discussed below. A tertiary label 9 remains attached to the CD box itself. The outer box containing the CD, or a plurality of CDs, then enters the distribution and retail chain, but may be scanned at any time by a scanner 10, which allows the association between the inner (primary) label and the outer (secondary) label to be verified.

In this example, the secondary label is encoded so that it is more complex in terms of its data content, and so that it also contains information about what the primary label attached to the internal article should read if the two parts are correctly “matched”. It is advantageous for the primary label to be simpler in content and readability to allow the primary label to be scanned when packaged within the box 200. A third part of the label, which becomes a tertiary label, can be detached from the CD or the box by a user and applied to their equipment to allow for the auditing of the installed software. This preferably consists of optically encoded data and may or may not contain additional magnetically encoded data. The data content of the tertiary label may also be linked or associated with the content of the primary/secondary labels or may simply allow the identification of the product manufacturer to be determined.

FIG. 1C illustrates a number of examples of multi-part label configurations embodying the present invention. Each of the labels consist of three parts A, B and C.

Part A is intended to be the secondary label which will be removed and attached to the outer packaging. This contains a more complex magnetic code which will usually require interrogation at relatively close range.

Part B is intended to be the primary label which will remain attached to the consumer article, and which contains a simple magnetic code that may be read at greater range (e.g. through packaging). The data content of part B is associated with the data content of part A.

Part C is intended to be the tertiary label and is also removable and may be detached from a consumer article by an end user and applied to equipment that operates in accordance with, or interacts with, a device such as a PC.

FIG. 2 illustrates an embodiment of the present invention in which a secondary label 15 is encoded with information about the properties of four primary labels 11, 12, 13 and 14. It is important that the primary labels can be read through the shipping case and for this reason labels utilising radio frequency or magnetic techniques are envisaged.

When the products are packed in the shipping case, they may be packed in a uniform and consistent manner. This means that regular positions within the shipping case can easily be scanned so that the identity of one, or a number, of given product positions can be established (e.g. the internal box numbers at the four locations may be 123, 443, 763 and 956). When the shipping case is fully packed and sealed, the inner product boxes are then read, according to a predetermined and known procedure, by a hand held reader such as that illustrated in FIG. 4, to determine their identity. The information is then encrypted and contained within the secondary label (e.g. encoded as 123443763956). Therefore, by reading the secondary label at any time in the distribution chain, and following the predetermined and known procedure when scanning one or more of the primary labels, it is possible to determine if the case has been tampered with. Even untrained personnel could rapidly and effectively carry out checks in accordance with preferred embodiments of the present invention. The procedure for packing/scanning can be altered as frequently as necessary.

In a simpler embodiment as illustrated by FIG. 3, one of the inner products 20 is provided with a primary label 21 and the products are packaged randomly within the box. Using a reader such as that shown in FIG. 4, the position of the tagged article within the case is determined and the positional information is encoded in the secondary label 22. If tampering were to occur, it is very likely that the position of the tagged article within the box would be altered, so that the required association between the labels would no longer exist. Alternatively, the article may be entirely replaced so that no response would be detected during an inspection or verification process. Obviously a higher level of security can be obtained by providing a plurality of articles within the case with primary labels. A further advantage of this embodiment is that since each case will have a unique set of references it is possible for cases to traced making it easier to find diverted products and to establish the cause of diversion.

FIG. 4 shows a hand held reader 25 which can read through the outer packaging of a case or shipping container 28 to read or detect the presence of labels 26 and 27 provided on articles within the container. In the embodiment described with reference to FIG. 2, where the positions of the primary labels are known, it is envisaged that the reader is provided with a guide/lip which controls the positioning of the reader from the edge of the container so that minimum effort is required to scan the inner label(s).

A number of different types of remotely readable labels may be used in accordance with the present invention. For example labels which employ magnetic, RFID, ultrasonic or optical technology are all envisaged.

Preferred embodiments of the present invention make use of magnetic tags which employ magnetic technology such as those described in WO 97/04338 and WO 96/31790, the disclosures of which are incorporated herein by way of reference thereto.

In particular, preferred embodiments use a magnetic interrogation technique which employs a magnetic “null” plane to interrogate the labels. As explained in WO 96/31790, a magnetic null plane consists of a region of zero magnetic field which, when considered in the same direction as the region of zero magnetic field, is contiguous with a region of high saturating magnetic field. By causing relative movement between the null plane and the magnetic material of the labels, the presence or the labels and any information magnetically encoded by the labels can be determined.

For example, one part of the label may consist of a plurality of magnetic elements which are arranged on a substrate such that the spacing between them is used to represent a code. In this way, the label may advantageously be encoded with information about the article to which the label is to be attached, e.g. manufacturer, supplier or cost. This can be particularly useful for verifying the authenticity of the article manufacturer. The magnetic properties of the elements themselves may also be used as a further means to encode information so that some, or all, of the elements has a unique attribute.

Preferably, the magnetic material comprises low coercivity, high permeability (≧10000) magnetic material which is advantageously in the form of a thin film of less than 1 micron thick and which preferably has a typical coercivity of less than 10 Gauss. The magnetic permeability of the material exhibits a preferred axis of magnetisation so that when the material is excited with an ac magnetic field parallel to the preferred axis of permeability, the material will be easily saturated. The magnetic field of the saturated material will comprise a non-linear function of the interrogation field, and will consist of harmonics of the exciting field. The presence of these harmonics will indicate the presence of the material so that a response signal can be obtained in which there exists a relationship between the time domain of the response and the spatial arrangement of the magnetic elements.

An alternative label/tag configuration which may comprise one part of the tag is described in detail in WO 97/04338, and comprises a first layer of magnetic material characterised by high permeability, low coercivity and a non-linear B-H characteristic. The low coercivity layer is coated with a second layer of magnetic material which is capable of being permanently magnetised so that it acts as a magnetic bias region. When the tag is interrogated by a suitable interrogation field the low coercivity layer will be driven out of saturation when the magnetic bias level of the neighbouring layer is overcome. In more complex tag configurations, the said second layer of magnetic material can comprise three or more discrete regions of magnetic bias material and each of the discrete regions can exhibit a different combination of magnetisation level and direction such that, during interrogation by a constant frequency alternating magnetic field, the magnetic bias levels of each of said discrete regions are overcome at different times in the interrogation cycle. In this way the value of magnetic bias field required to overcome the high coercivity layer can uniquely identify an element and therefore the information that it represents.

The interrogation field in this embodiment, which may be generated by a reader such as that shown in FIG. 4, comprises a high amplitude, low frequency scanning field which is capable of overcoming the bias of the high coercivity layer. In addition, a low amplitude, high frequency field is generated to which the low coercivity layer will respond only when the neighbouring bias has been overcome by the scanning field. The high frequency field creates signals which are harmonics of the interrogation frequency and which are detected by the receive coil. The presence of these harmonics will indicate the presence of this material.

FIG. 5A shows the way in which a plurality of multi-part labels 31 may be manufactured and applied to a substrate reel 32 in order to provide a means embodying the present invention. Secondary label 37 and a tertiary label 38 are applied to a substrate label 36 using a label applicator 33, the label 36 becoming the primary label. A reading device 34 is employed which subjects primary label 36 to an interrogation field so as to read a registered magnetic label embedded within the primary label 36. The magnetic properties of the primary label (and thus the encoded information) are determined by the reader and are subjected to a sophisticated algorithm, in accordance with which all three labels are printed with an encrypted optical bar code and a human readable reference, by means of a printer 39.

FIGS. 5B and 5C show further examples of multi-part labels manufactured by a similar technique.

1. A method of providing means for detecting counterfeit articles and/or for detecting unauthorised tampering of articles/article packaging, the method comprising the steps of:
i) determining one or more properties of an at least one primary label or of an article to which at least one primary label is, or is to be, attached; and
ii) encoding at least one secondary label with information about the one or more properties determined in step (i), such that there exists an association between the information contained in the or each secondary label and one or more of the properties of the or each primary label, or of an article to which the or each primary label is attached, wherein the or each primary label is provided on an article contained within a container holding a plurality of articles, and wherein the secondary label is provided on the outside of the container.

2. A method as claimed in claim 1, wherein the one or more properties determined in step (i) is the information encoded by one or more primary labels provided on consumer product(s) packed at predetermined positions within the container.

3. A method as claimed in claim 1, wherein the or each primary label acts as a presence indicator.

4. A method as claimed in claim 1, wherein the one or more properties determined in step i) represents positional properties of the or each primary label, or the article to which the or each primary label is, or is to be, attached.

5. A method as claimed claim 2, wherein the one or more properties determined in step i) represents the information encoded by the or each primary label.

6. A method of detecting counterfeit articles and/or detecting unauthorised tampering of articles/article packaging, the method comprising the steps of:
i) determining one or more given properties of at least one primary label, or the an article to which at least one primary label is attached, the or each primary label being provided on an article contained within a container holding a plurality of articles;
ii) determining information encoded by at least one secondary label, the secondary label being provided on the outside of the container; and
iii) checking for the existence of a predetermined association between the information determined in steps i) and ii).

7. A method as claimed in claim 6, wherein the one or more propeties determined in step (i) is information encoded by one or more labels provided on the consumer product(s) packed at predetermined positions within the container.

8. A method as claimed in claim 6, wherein the one or more properties determined in step i) comprises positional properties of the or each primary label, or the article to which the or each primary label is attached.

9. A method as claimed in claim 6, wherein the one or more properties determined in step i) comprises information encoded by the or each primary label.

10. A method as claimed in claim 6, wherein the or each primary label comprises remotely detectable magnetic material.

11. A method as claimed in claim 10, wherein said magnetic material comprises low coercivity, high permeability magnetic material.

12. A method as claimed in claim 10, wherein information is obtained in step (i) by means of a reading device which employs an interrogation field comprising an ac field arranged so as to be parallel with preferred axis of permeability of the magnetic material.

13. A method as claimed in claim 6, wherein information determined in step (i) is obtained by means of a reading device which employs an interrogation field comprising a high amplitude, low frequency scanning field and a low amplitude, high frequency field.

14. A method as claimed in claim 6, wherein the or each primary label is capable of being read by means of a reading device which operates in accordance with non-contact interrogation techniques.

15. A method as claimed in claim 6, wherein the or each primary label is capable of being read by means of a reading device operating in accordance with techniques which do not require a line of sight between the reading device and the or each primary label.

16. A system for detecting counterfeit articles and/or detecting unauthorised tampering of articles/article packaging, the system comprising at least one primary label provided on an article contained within a container holding a plurality of articles, and at least one secondary label provided on the outside of the container, wherein there exists an association between the information contained in the or each secondary label and one or more of the properties of the or each primary label.

17. A system as claimed in claim 16, wherein information contained in the or each secondary label is related to information encoded by the label attached to at least one article packaged at a predetermined location within the container.

18. A system as claimed in claim 16, wherein information contained in the or each secondary label represents positional properties of the or each primary label, or the article to which the or each primary label is attached, within the container.

19. A system as claimed in claim 16, wherein there exists an association in the data content of the or each primary label and the or each secondary label.

20. A system as claimed in claim 16, wherein the or each primary label comprises remotely detectable magnetic material.

21. A system as claimed in claim 20, wherein said magnetic material comprises low coercivity, high permeability magnetic material.

22. A system as claimed in claim 16, wherein the primary label is provided with a simpler code than the secondary label, and wherein the secondary label is encoded with information about information contained in the primary label.
